(19) United States
(12) Patent Application Publication
(10) Pub. No.: US 2009/0106983 A1
(43) Pub. Date: Apr. 30, 2009

(54) Knife

(75) Inventor: Harald Berns, Wuppertal (DE)

Correspondence Address: WILDMAN HARROLD ALLEN & DIXON LLP, 225 WEST WACKER DRIVE, SUITE 2800, CHICAGO, IL, 60606, US

(73) Assignee: Martor KG, Solingen (DE)

(21) Appl. No.: 12/261,705

(22) Filed: Oct. 30, 2008

(30) Foreign Application Priority Data
Oct. 30, 2007 (DE) 102007052060.5-15

(51) Int. Cl. B26B 3/06

(52) U.S. Cl. 30/162

(57) ABSTRACT

Presented and described inter alia is a knife comprising a housing (11) and a blade carrier (12) holding a knife blade (13), which is movable between a protected position in which the knife blade (13) is disposed inside the housing (11), and a cutting position in which the knife blade (13) projects from the housing (11), wherein the blade carrier (12) is loaded by a restoring element (18) into the protected position, comprising an actuating device (14) to move the blade carrier (12) from the protected position into the cutting position, wherein at least one coupling device is provided for detachable movement connection of the actuating element (14) and the blade carrier (12).

The particular feature is that the coupling element (21) and the counter-coupling element (25) are configured to be immovably rigid.

The invention relates to a knife according to the preamble of claim 1.

Such a knife is known, for example, from DE 197 23 279 C1. The knife comprises a blade carrier and an actuating element, wherein blade carrier and actuating element are provided with coupling elements which can be brought into engagement for moving the blade carrier from a protected position where it is withdrawn into the housing into a cutting position where it projects beyond the housing. The cooperating coupling elements can be released by the cutting force, whereby the blade carrier is withdrawn by a spring into the protected position even when the actuating element is pushed forwards. An additional movement of the blade carrier in the direction of extension is required to decouple the coupling elements.

Furthermore, knives are known in which the blade carrier is pivotable for coupling or decoupling the cooperating coupling elements.

It is the object of the invention to provide a knife that can be manufactured easily and reliably prevents cutting injuries.

The object is achieved according to a first aspect of the invention by a knife having the features of claim 1.

The principle of the invention consists in that the blade carrier has a coupling element and the actuating element has a counter-coupling element and that both coupling elements can be detachably brought into engagement in order to move the blade carrier from a protected position into a cutting position and hold it therein. The counter-coupling element is configured to be immovable with respect to the actuating element. The coupling element is configured to be immovable with respect to the blade carrier. A coupling or release of the coupling of the coupling elements is effected by a movement of the blade carrier and/or the actuating element as a whole. The counter-coupling element can, for example, be connected in one piece to the actuating element. The coupling element can, for example, be connected in one piece to the blade carrier. Consequently, no elastic deformation of the coupling elements is required to move, for example, the blade carrier from the coupling position into the uncoupling position. Also no relative movement of the coupling element with respect to the blade carrier and of the counter-coupling element with respect to the actuating element is required.

Coupling element or counter-coupling element in the sense of the invention are parts of a coupling device which are provided on the blade carrier and the actuating device to allow a detachable movement coupling between the blade carrier and the actuating device. Alternatively or additionally, the coupling device can be provided between the blade carrier and the housing. Alternatively or additionally, the coupling device can be provided between the actuating element and the housing. At least one of the coupling elements is movable from the movement path of the other coupling element so that decoupling can be effected between blade carrier and actuating device. For example, the blade carrier can have at least one coupling element which cooperates with a counter-coupling element of the actuating device and at least one other coupling element which cooperates with a counter-coupling element of the housing.

For example, the blade carrier is mounted in the housing so that it can move between at least one coupling position and at least one decoupling position. Alternatively, for example, the actuating element can be movably mounted. Also alternatively, both the blade carrier and also the actuating element can be movably mounted. According to the first aspect of the invention, this can comprise any type of movement such as linear movement or pivoting movement. According to the second and the third aspect of the invention, the blade carrier and/or the actuating element are movable by a pivoting movement between a coupling position and the decoupling position. In the coupling position, the coupling elements of blade carrier and actuating device are in engagement so that the blade carrier with pre-displaced actuating device cannot revert back into the protected position. In the decoupling position, the cooperating coupling elements are not located on a common movement path. The blade carrier can also revert back into the protected position with a pre-displaced actuating device.

In the cutting position the blade carrier can be located both in the coupling position and in the decoupling position. In the decoupling position, the blade carrier can be held in the cutting position as a result of the cutting reaction force.

Restoring element in the sense of the invention can, for example, be a spring element. The spring element can be formed, for example, by a helical tension spring. The restoring element exerts a restoring force on the blade carrier. The moment produced by the restoring force is designated as restoring moment.

The actuating device exerts an actuating force on the blade carrier. The moment acting on the blade carrier as a result of the actuating force is designated as actuating moment.

A cutting force acting on the blade produces a cutting moment acting on the blade carrier since the blade is motionally connected to the blade carrier.

The pivotal mounting of the blade carrier can be effected, for example, by a rounding of the outer contour of the blade carrier. Alternatively, for example, cooperating means can be provided on the blade carrier and on the knife housing, which allow both a pivoting of the blade carrier and also a linear movement between the protected position and the cutting position.

“Configured to be rigidly immovable” in the sense of the invention means that neither a relative movement of the coupling element with respect to the actuating element or the blade carrier nor an elastic deformation of the first and the second actuating element can take place. In particular, all the coupling elements and all the counter-coupling elements are configured to be rigidly immovable.

The advantage of the invention is that due to the rigid configuration of the coupling elements, the safety function of the knife is ensured over the entire lifetime of the knife. In particular, if the blocking means are made of plastic, no material fatigue occurs due to ageing or overstressing of the material. By means of the features according to the invention, a stable design of the knife is possible so that the knife can be used, for example, when high cutting forces occur. In addition, the knife can be produced constructively simply and brings about only low production costs.

The object is achieved according to a second aspect of the invention by a knife having the features of claim 2.

The principle of the invention consists in that, for example, the blade carrier is held pivotably in the housing. A restoring force acts on the blade carrier in such a manner that a restoring moment is directed in the opposite direction to a cutting movement. In this way, the blade carrier can be held in the coupling position until a certain cutting moment is achieved which brings about a movement of the blade carrier. By means of the features according to the invention, a pre-loading of the blade carrier in the coupling position is therefore effected. Alternatively or additionally, the actuating element can also be pivotally mounted and pre-loaded in the coupling position.

The advantage of the invention is that due to the restoring moment produced by the restoring force, no additional means are required to hold the coupling elements in engagement until the blade engages in the material to be cut. The restoring moment is therefore determined in such a manner that the blade can penetrate into the material to be cut.

According to one embodiment, an actuating force acts on the blade carrier such that it exerts no moment on the blade carrier. For example, the line of action of the actuating force runs substantially through the pivot point of the blade carrier. Since in this case, the actuating force has no lever arm, no torque acts on the blade carrier.

The object is achieved according to a third aspect of the invention by a knife having the features of claim 3.

The principle of the invention is that an actuating force acts on the blade carrier such that an actuating movement is directed in the opposite direction to the cutting moment. The blade carrier then remains in the coupling position until the cutting moment causes a movement of the blade carrier and/or the actuating element.

With regard to the advantages, reference is made to the explanations relating to claim 2.

According to one embodiment, the cooperating contact faces are configured as blocking faces which counteract any movement of the blade carrier and/or the actuating element into the decoupling position. The blocking faces can prevent the movement of the blade carrier and/or the actuating device in at least one direction. The blocking faces can be configured, for example, in such a manner that the blade carrier or the actuating device must execute an additional movement to enter into the decoupling position. This can, for example, comprise a linear movement.

According to a further embodiment, the coupling element and the counter-coupling element cooperate positively. The form closure can be configured, for example, in such a manner that a certain force on the blade overcomes the form closure so that the coupling elements come out of engagement. The form closure can be overcome, for example, by a movement of the blade carrier which differs from the rotary movement. This can, for example, be a longitudinal movement in the feed direction of the blade.

According to a further embodiment of the invention, at least one of the coupling faces is inclined to a pivoting direction. Due to the inclination, the force acting on the coupling face can be deflected into a force acting in another direction. The inclination can, for example, be configured in such a manner that a decoupling is only possible due to a movement of the blade carrier in the longitudinal direction of the knife.

According to a further embodiment, the coupling element and the counter-coupling element have cooperating contact faces, wherein one contact face is convexly configured and the other contact face is concavely configured. The pivot point of the blade carrier can, for example, be the radial midpoint of the convex or concave curvature. Alternatively, for example, the convex region can have an arrow-shaped tip and the concave region can have a complementary approximately arrow-shaped recess.

According to a further embodiment of the invention, the blade carrier is movable from the coupling position merely in a first pivoting direction into the decoupling position. In this way, it is possible to provide the blade carrier with a pre-stressing moment in one pivoting direction without the blade carrier pivoting as a result of the pre-stressing moment. The pre-stressing movement can be produced at least partly, for example, by the restoring force of the restoring element. A movement into the decoupling position is only made from a certain cutting moment at which the pre-stressing moment is overcome.

According to a further embodiment of the invention, the blade carrier is supported in a second pivoting direction on a region fixed to the housing. In this way, a pre-stressing moment acting on the blade carrier can be absorbed by the housing. The blade carrier can, for example, be supported directly on the housing. Alternatively, the blade carrier can be supported, for example, indirectly on the housing.

According to a further embodiment of the invention, the force application point of the restoring element lies on a line of action of the actuating force. Since the actuating force corresponds to the restoring force, no moment is exerted on the blade carrier. A moment caused by the actuating force in the direction of the cutting moment can thereby by prevented.

According to a further embodiment of the invention, the force application point of the restoring element lies outside a line of action of the actuating force. In this case, different moments are exerted on the blade carrier.

Further advantages of the invention are obtained from the non-cited dependent claims and with reference to the exemplary embodiments shown in the figures. In the figures:

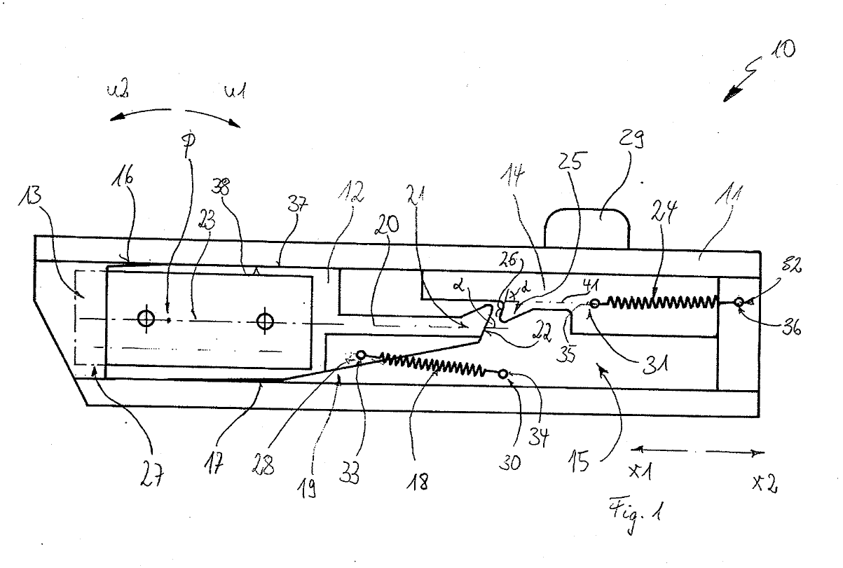

FIG. 1 shows a schematic side view of the knife in the protected position,

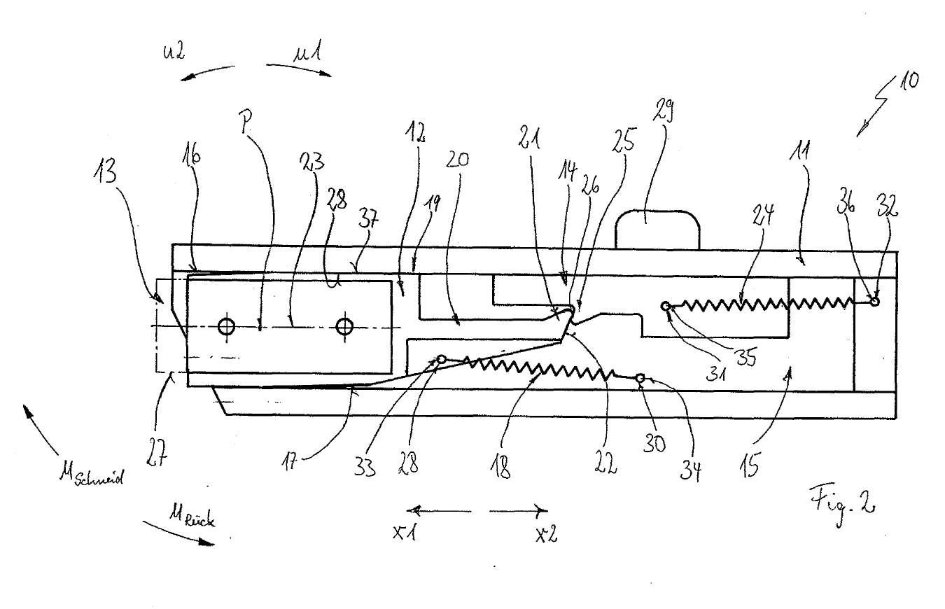

FIG. 2 shows a schematic sectional view, based on FIG. 1, of the knife in the cutting position, wherein the coupling element and the counter-coupling element are disposed in a coupling position,

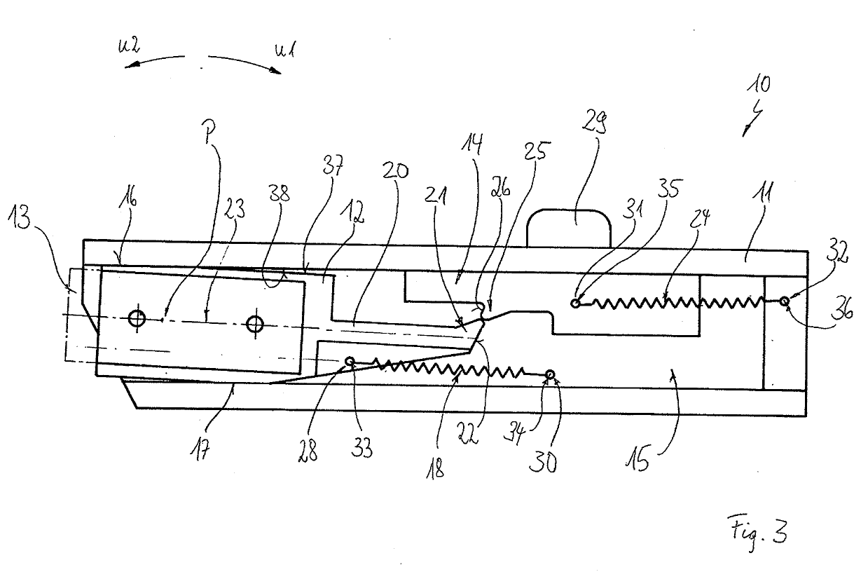

FIG. 3 shows a schematic sectional view, based on FIG. 2, of the knife in the cutting position, wherein the coupling element and the counter-coupling element are disposed in a decoupling position,

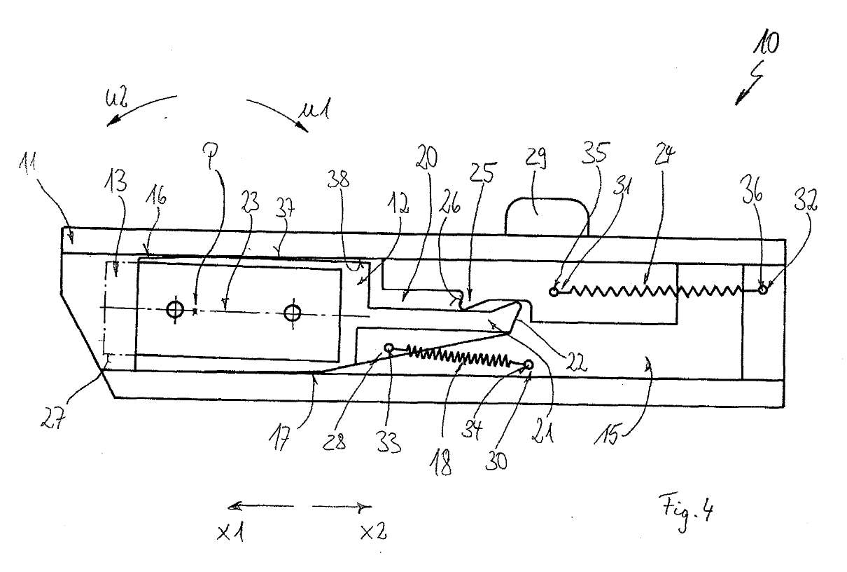

FIG. 4 shows a schematic sectional view, based on FIG. 3, of the knife wherein the blade carrier is in the protected position and the actuating element is in a pre-displaced position,

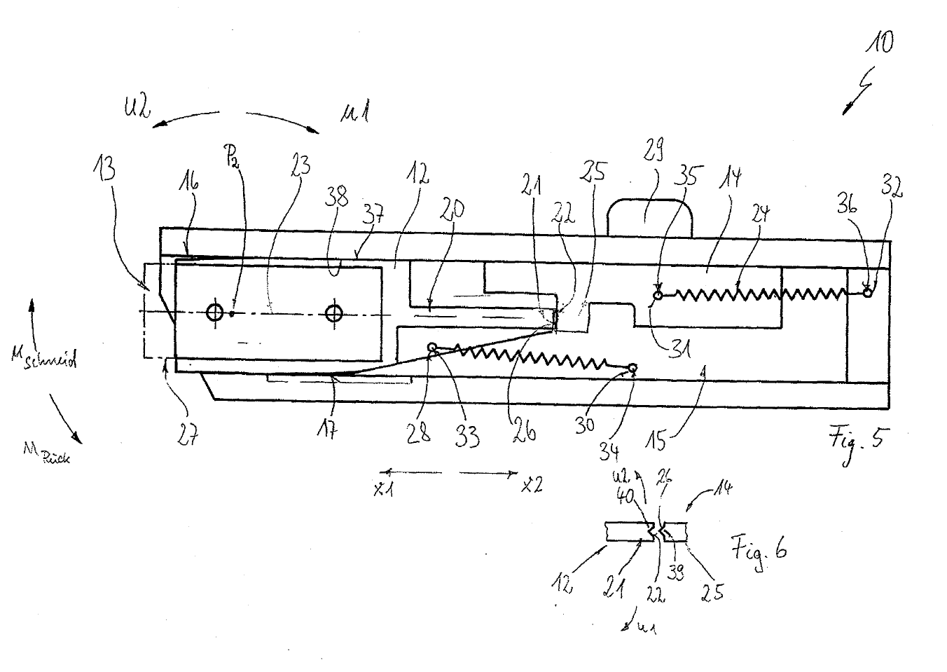

FIG. 5 shows a schematic sectional view of an alternative embodiment of the knife, wherein a line of action of the actuating force runs through the pivot point of the blade carrier,

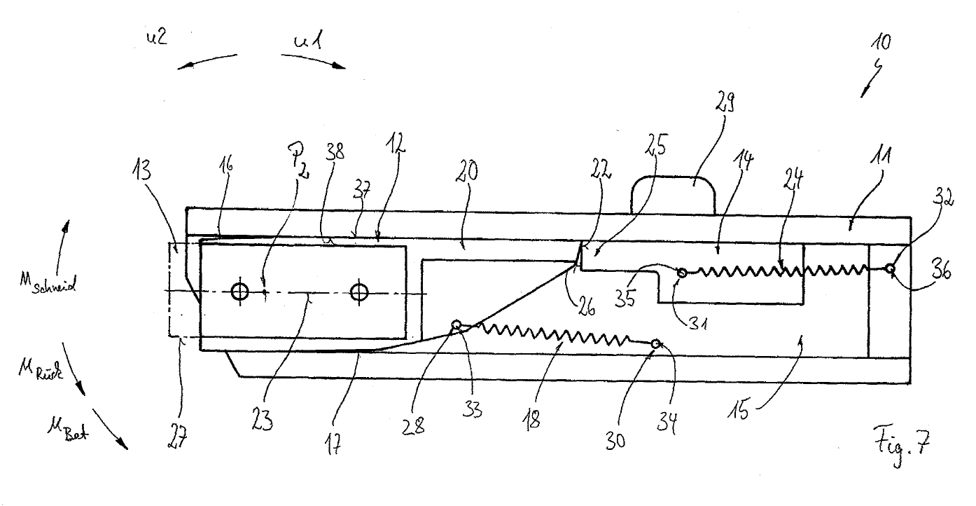

FIG. 6 shows a section along the line of intersection VI in FIG. 8,

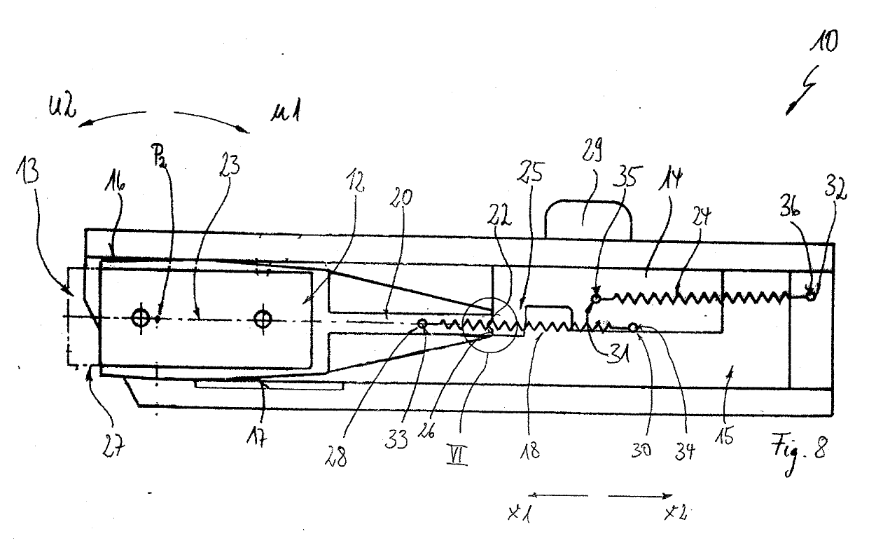

FIG. 7 shows a schematic sectional view of an alternative embodiment of the knife,

FIG. 8 shows a schematic sectional view of an alternative embodiment of the knife, wherein lines of action of the actuating force and the restoring force run. through the pivot point of the blade carrier.

A knife is overall designated with the reference numeral 10 in the figures. The same reference numerals in the different figures designate corresponding components with added or omitted lower-case letters.

The knife 10 substantially comprises a housing 11, a blade carrier 12 with a blade 13 and an actuating device 14. The blade carrier 12 is displaceably received in a channel 15 of the housing 11. It can be moved between a protected position (see FIGS. 1 and 4) in which the blade 13 is withdrawn into the housing 11 and a cutting position (see FIGS. 2 and 3) in which the blade 13 projects over the housing 11. Two projections of the blade carrier 12 positively engage recesses of the blade 14 to hold the latter on the blade carrier 12.

The blade carrier 12 can be pivoted, for example, from the position shown in FIG. 2 about a pivot point P in direction u1 into the position shown in FIG. 3. A pivoting of the blade carrier 12 is also possible into positions located between the protected position according to FIG. 1 and the cutting position according to FIG. 2. In the exemplary embodiment according to FIGS. 1 to 4, the blade carrier cannot pivot from the position shown in FIG. 2 in direction u2 since an outer face 37 of the blade carrier 12 abuts against a housing wall 38.

In order to allow pivoting in direction u1, oblique faces 16 and 17 are provided on the blade carrier 12. The pivot point P need not necessarily be a constant point of the blade carrier 12. For example, a radius can be provided on the blade carrier 12, wherein in each case, a point on the radius abuts at least indirectly on the housing 11.

A spring element 18 is fastened with a retaining means 28 on one counter-retaining means 33 of the blade carrier 12 and with a retaining means 30 on a counter-retaining means 34 of the housing 11. The blade carrier 12 is loaded by the spring element 18 into the protected position according to FIGS. 1 and 4.

At its rear end 19, the blade carrier 12 has an arm 20 with a coupling element 21. The coupling element 21 is provided with a coupling face 22. The coupling face 22 is inclined by an angle a with respect to a longitudinal central axis 23 of the blade carrier 12. The entire blade carrier 12 including the coupling element 21 is configured in one piece as a rigid component, in particular as a plastic injection-moulded component. The coupling element 21 is Notionally connected to the blade carrier 12.

The actuating device 14 is moveable between a withdrawn position according to FIG. 1 and a pre-displaced position according to FIGS. 2 to 4. In order to move the actuating device 14 into the cutting position, a handle 29 is firmly connected to the actuating device 14. A spring element 24 is held with a retaining means 31 on a counter-retaining means 35 of the actuating device 14 and with a retaining means 32 on a counter-retaining means 36 of the housing 11. The actuating device 14 is loaded by the spring element 24 in to the withdrawn position.

The actuating device 14 has a counter-coupling element 25 with a coupling face 26. The coupling face 22 is disposed at an angle a with respect to a longitudinal central axis 41 of the actuating device 14. The actuating device 14 together with the counter-coupling element 25 is also configured as a one-piece rigid component, in particular as a plastic injection-moulded component.

When the actuating device 14 is advanced in direction x1 by means of the handle 29, the coupling element 21 and the counter-coupling element 25 come in contact. During a further advance of the actuating device, the blade carrier 12 is entrained forwards by the actuating device 14.

According to FIG. 2, the actuating device 14 is located in the frontmost pre-displaced position and the blade carrier 12 is located in the cutting position. The coupling element 21 and the counter-coupling element 25 are engaged. Both the spring element 28 and also the spring element 24 are tensioned. The blade 13 projects beyond the housing 11.

If the blade 13 is placed on a material to be cut, which is not shown, a cutting force acts on a cutting edge 27 of the blade 13. Due to the cutting force, a cutting moment M_{cut} is produced about the pivot point P in pivoting direction u2. If the cutting moment M_{cut} is sufficient to cause a pivoting of the blade carrier 12 in pivoting direction u2, the coupling element 21 and the counter-coupling element 25 according to FIG. 3 disengage. Since the counter-coupling element 25 according to the position shown in FIG. 3, is no longer located in the movement path of the coupling element 21 of the blade carrier 12, the blade carrier 12 can be withdrawn by the spring element 18 in direction x2 into the protected position according to FIG. 4, although the actuating device 14 is disposed in the pre-displaced position.

After the blade 13 has penetrated into the material to be cut, the cutting force can hold the blade carrier 12 in the cutting position. If the cutting force is greater than the restoring force of the restoring element 18, the blade carrier 12 remains in the cutting position although the coupling element 21 and the counter-coupling element 25 are moved into a decoupling position and are therefore out of engagement.

In the knife 10 according to the invention as in FIGS. 1 to 4, the fastening point 28 of the spring element 18 is at a distance from the pivot point P. A restoring moment Mᵣₑₛₜ resulting from the restoring force acts in direction u2 against the cutting moment M_{cut}. The cutting moment M_{cut} acts in direction u1.

The line of action of the actuating force runs on the longitudinal axis 23 of the blade carrier 12 and produces no moment.

The restoring moment Mᵣₑₛₜ is determined such that a minimum cutting moment M_{cutmin} is required to decouple the coupling element 21 and the counter-coupling element 25. The cutting moment M_{cutmin} is sufficient to ensure penetration of the blade 13 into the material to be cut without the coupling element 21 being previously moved out of engagement with the counter-coupling element 25.

According to an alternative embodiment shown in FIG. 5, the coupling element 21 is disposed in such a manner that the line of action of the actuating force runs substantially through the pivot point P. The actuating force then produces no moment M_{act}.

According to an alternative embodiment shown in FIG. 7, the coupling element 21 and the counter-coupling element 25 are disposed at a distance from the pivot point P such that the actuating force produces a moment M_{act} which acts in the opposite direction to the cutting moment M_{cut} in direction u2. The restoring element 18 produces a restoring moment Mᵣₑₛₜ in direction u2 which also acts in the opposite direction to the cutting moment M_{cut}.

In the exemplary embodiment shown in FIG. 8, the blade carrier 12 is pivotable both in the direction u1 and also in the direction u2. The coupling element 21 and the counter-coupling element 25 have complementary form-closure element (see FIG. 6). The coupling element 21 is provided with a roof-shaped recess 40, the counter-coupling element 25 is provided with a roof-shaped projection 39. By means of the embodiment of the coupling element 21 and the counter-coupling element 25 according to FIG. 6, it is possible to configure the knife as a right/left-handed knife so that decoupling is possible in both pivot directions u1, u2. Pivoting of the blade carrier 12 is then prevented, for example, until a force acting in direction x1 is sufficiently large to move the blade carrier 12 from the form closure in direction x1. The counter-coupling element 25 is then no longer located in the movement path of the coupling element 21 and pivoting of the blade carrier 12 in direction u1 is possible.

1. A knife comprising a housing (11) and a blade carrier (12) holding a knife blade (13), which is movable between a protected position in which the knife blade (13) is disposed inside the housing (11), and a cutting position in which the knife blade (13) projects from the housing (11), wherein the blade carrier (12) is loaded by a restoring element (18) into the protected position, comprising an actuating device (14) to move the blade carrier (12) from the protected position into the cutting position, wherein at least one coupling device is provided for detachable movement connection of the actuating element (14) and the blade carrier (12) comprising at least one coupling element (21) assigned to the blade carrier (12) and at least one counter-coupling element (25) which is assigned to the actuating element (14) and/or the housing (11), and wherein in a coupling position, the counter-coupling element (25) is in engagement with the coupling element (21) and in a decoupling position, the counter-coupling clement (25) is decoupled from the coupling element (21), characterised in that the coupling element (21) and the counter-coupling element (25) are configured to be immovably rigid.

2. A knife comprising a housing (11) and a blade carrier (12) holding a knife blade (13), which is movable between a protected position in which the knife blade (13) is disposed inside the housing (11), and a cutting position in which the knife blade (13) projects from the housing (11), wherein the blade carrier (12) is loaded by a restoring element (18) into the protected position, comprising an actuating device (14) to move the blade carrier (12) from the protected position into the cutting position, wherein a coupling device is provided with at least one coupling element (25) assigned to the blade carrier (12) and at least one counter-coupling element (21) which is assigned to the actuating element (14) and/or the housing (11), and wherein the blade carrier (12) is pivotable about a pivot point (P) between a coupling position in which the counter-coupling element (21) is in engagement with the coupling element (25) and a decoupling position in which the counter-coupling element (21) is decoupled from the coupling element (21), characterised in that the restoring element (18) acts on the blade carrier (12) in relation to the pivot point (P) in such a manner that a resulting moment (Mᵣₑₛₜ) is directed in the opposite direction to a cutting moment (M_{cut}).

3. The knife according to the preamble of claim 2, characterised in that the actuating device (14) acts on the blade carrier (12) in relation to the pivot point (P) in such a manner that a resulting moment (M_{act}) is directed in the opposite direction to a cutting moment (M_{cut}).

4-14. (canceled)
